(19) United States
(12) Patent Application Publication
(10) Pub. No.: US 2025/0348859 A1
(43) Pub. Date: Nov. 13, 2025

(54) SYSTEM AND METHOD FOR PROCESSING AND STORING GLOBAL PAYMENT DATA

(71) Applicant: Mastercard International Incorporated, Purchase, NY (US)

(72) Inventors: Devanshu Bhardwaj, Hisar (IN); Kaushal Shetty, O'Fallon, MO (US); Krupal Ghorpade, Kolhapur (IN); Mayank Joshi, Pune (IN)

(73) Assignee: Mastercard International Incorporated, Purchase, NY (US)

(21) Appl. No.: 18/657,952

(22) Filed: May 8, 2024

(51) Int. Cl. G06Q 20/22; G06Q 20/34

(52) U.S. Cl. CPC G06Q 20/22; G06Q 20/34

(57) ABSTRACT

A system and method for facilitating an international payment card-based or other financial transaction by evaluating multiple international pathways for transaction processing and data storage and identifying and using an optimum pathway between the origination and destination countries for these processes. The origination and destination countries are assigned country categories based on localization requirements for the transaction processing and data storage processes, and a first pathway is identified, evaluated based on relevant criteria, and scored. Alternative pathways through intermediate countries are similarly identified, evaluated, and scored. The evaluations and the resulting scores may be based on, e.g., available infrastructure and the financial and performance costs of using the available infrastructure. The scores are compared to identify the optimum path, and the optimum path is used to facilitate the international financial transaction. The transaction processing process and data storage process may involve the same optimum pathway or different optimum pathways.

### FIELD

The present invention relates to systems and methods for facilitating international financial transactions, and more particularly, embodiments concern a system and method for facilitating an international financial transaction by evaluating multiple international pathways for transaction processing and data storage and identifying and using an optimum pathway for these processes between the transaction origination and destination countries.

### BACKGROUND

Payment companies must be aware of and comply with the most current laws and regulations of each country or region in which they operate. Compliance can involve a variety of different factors in both the origination and destination countries, such as cross-border payment processing and data transfer, anti-money laundering (AML) laws, Know Your Customer (KYC) requirements, Payment Card Industry Data Security Standards (PCI DSS), and sanctions laws. Failure to do so can result in significant fines, reputational damage, and loss of business.

This background discussion is intended to provide information related to the present invention which is not necessarily prior art.

### SUMMARY

Embodiments of the present invention address the above-described problems and limitations by providing a system and method for facilitating an international financial transaction by evaluating, based on, e.g., cost and latency factors, multiple international pathways for transaction processing and data storage and identifying and using an optimum pathway for these processes between the transaction origination and destination countries.

In a first embodiment, a system is provided for facilitating an international financial transaction. The system may include a merchant, an issuer, one or more transaction processing infrastructures and one or more data storage infrastructures, and an optimum pathway identification module. The merchant may be located in a transaction origination country associated with a first set of localization requirements for a transaction processing process and a data storage process. The issuer may be located in a transaction destination country associated with a second set of localization requirements for the transaction processing process and the data storage process. The transaction processing infrastructures and the data storage infrastructures may be located in one or more intermediate countries. The optimum pathway identification module may be configured to function as follows; identify the transaction origination country and the transaction destination country for the international financial transaction; assign the transaction origination country to a first country category based on the first set of localization requirements for the transaction processing process and the data storage process; assign the transaction destination country to a second country category based on the second set of localization requirements for the transaction processing process and the data storage process; identify a first transaction processing and data storage pathway between the transaction origination country and the transaction destination country based on the first country category and the second country category; evaluate the first transaction processing and data storage pathway based on one or more relevant factors, and determine a first prioritization score for the first transaction processing and data storage pathway; identify one or more alternative transaction processing and data storage pathways between the transaction origination country and the transaction destination country through the one or more intermediate countries; evaluate the one or more alternative transaction processing and data storage pathways based on the one or more relevant factors, and determine an alternative prioritization score for each of the one or more alternative transaction processing and data storage pathways; compare the first prioritization score for the first transaction processing and data storage pathway and the alternative prioritization score for each of the one or more alternative transaction processing and data storage pathways; and select an optimum pathway for the transaction processing and data storage processes based on comparing the prioritization scores, and use the optimum pathway for the transaction processing process and the data storage process.

In a second embodiment, a method is provided for facilitating an international financial transaction. The method may include the following. An origination country and a destination country may be identified for the international financial transaction. The origination country may be assigned to a first country category based on a first set of localization requirements for a transaction processing process and a data storage process. The destination country may be assigned to a second country category based on a second set of localization requirements for the transaction processing process and the data storage process. A first transaction processing and data storage pathway may be identified between the origination country and the destination country based on the first country category and the second country category. The first transaction processing and data storage pathway may be evaluated based on one or more relevant factors, and a first prioritization score may be determined for the first transaction processing and data storage pathway. One or more alternative transaction processing and data storage pathways may be identified between the origination country and the destination country through one or more intermediate countries. The one or more alternative transaction processing and data storage pathways may be evaluated based on the one or more relevant factors, and an alternative prioritization score may be determined for each of the one or more alternative transaction processing and data storage pathways. The first prioritization score for the first transaction processing and data storage pathway and the alternative prioritization score for each of the one or more alternative transaction processing and data storage pathways may be compared. An optimum pathway for the transaction processing and data storage processes may be selected based on the prioritization scores, and the optimum pathway may be used for the transaction processing process and the data storage process.

Various implementations of the above-described embodiment may include any one or more of the following features. The first transaction processing and data storage pathway may include an intermediate country. The transaction processing process and the data storage process may use the same or different optimum pathways. The one or more relevant factors include an available infrastructure, a financial cost of using the available infrastructure, a performance cost, including a time cost, of using the available infrastructure. The one or more relevant factors for the transaction processing process include a region, a type of transaction processing infrastructure, a transaction volume processing requirement, and a licensing cost for a transaction processing software. The one or more relevant factors for the data storage process include a data security compliance and regulatory requirements, a storage requirement, a geographic distribution, and a pricing for relevant vendors and service providers.

This summary is not intended to identify essential features of the present invention, and is not intended to be used to limit the scope of the claims. These and other aspects of the present invention are described below in greater detail.

### BRIEF DESCRIPTION OF THE DRAWINGS

Embodiments of the present invention are described in detail below with reference to the attached drawing figures, wherein:

FIG. 1 is a high-level block diagram of an embodiment of a system for facilitating an international financial transaction by evaluating multiple international pathways for transaction processing and data storage and identifying and using an optimum pathway for these processes between the transaction origination and destination countries;

FIG. 2 is a flowchart of a first embodiment of a method for facilitating an international financial transaction by evaluating multiple international pathways for transaction processing and data storage and identifying and using an optimum pathway for these processes between the transaction origination and destination countries, wherein the transaction processing and data storage processes may use the same optimum pathway;

FIG. 3A is a first part of a flowchart of a second embodiment of a method for facilitating an international financial transaction by evaluating multiple international pathways for transaction processing and data storage and identifying and using an optimum pathway for these processes between the transaction origination and destination countries, wherein the transaction processing and data storage processes may use different optimum pathways;

FIG. 3B is a second part of the flowchart of the method of FIG. 3A;

FIG. 4 is a depiction of an example default transaction processing and data storage pathway for an example first international financial transaction, wherein the example default pathway is superimposed over a map of the world showing the transaction origination and destination countries; and

FIG. 5 is a depiction of an example optimum transaction processing and data storage pathway identified and used by an embodiment of the present invention for the first example international financial transaction of FIG. 4;

FIG. 6 is a depiction of an example default transaction processing and data storage pathway for an example second international financial transaction, wherein the example default pathway is superimposed over a map of the world showing the transaction origination and destination countries; and

FIG. 7 is a depiction of an example optimum transaction processing and data storage pathway identified and used by an embodiment of the present invention for the second example international financial transaction of FIG. 6.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly, embodiments provide a system and method for facilitating an international financial transaction (such as a payment card-based financial transaction) by evaluating, based on, e.g., cost and latency factors, multiple international pathways for transaction processing and data storage and identifying and using an optimum pathway for these processes between the transaction origination and destination countries. In one implementation, the transaction processing and data storage processes may use the same optimum pathway, while in another implementation, the transaction processing process may use an optimum transaction processing pathway and the data storage process may use an optimum data storage pathway, and the two pathways may be different.

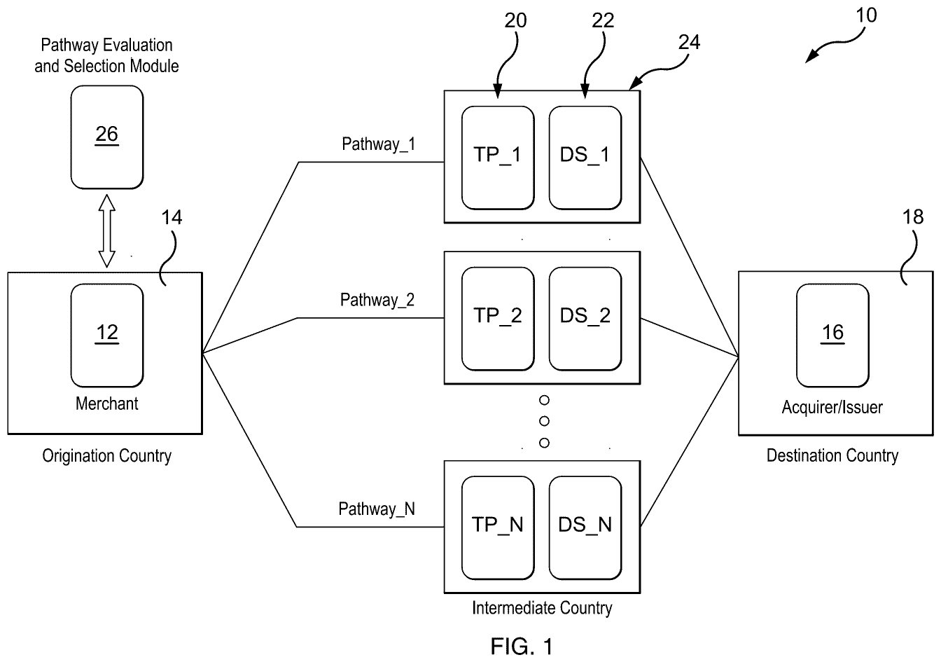

Referring to FIG. 1, an embodiment of a system 10 and its operational context is shown for facilitating an international financial transaction (such as a payment card-based financial transaction) by evaluating, based on, e.g., cost and latency factors, multiple international pathways for transaction processing and data storage and identifying and using an optimum pathway for these processes between the transaction origination and destination countries. The system 10 may broadly include a merchant 12 located in the transaction origination country 14, an issuer 16 located in the transaction destination country 18, a plurality of transaction processing infrastructures 20 and a plurality of data storage infrastructures 22 located in a plurality of intermediate countries 24, and an optimum pathway identification module 26.

The merchant 12 may be substantially any merchant engaged in international financial transactions. The transaction origination country 16 may be substantially any first country, and may have a first set of localization requirements (in the form of applicable laws and regulations) for the transaction processing and data storage processes of such financial transactions. The issuer 16 may be substantially any issuer associated with the payment card used in the financial transaction. The transaction destination country 18 may be substantially any second country which is not the first country, and may have a second set of localization requirements (in the form of applicable laws and regulations) for the transaction processing and data storage processes of such financial transactions.

The plurality of transaction processing infrastructures 20 and the plurality of data storage infrastructures 22 may include substantially any hardware, firmware, and/or software resources configured to perform the transaction processing process and the data storage process, respectively. The plurality of intermediate countries 24 may be substantially any third countries which are not the first or second countries and that have transaction processing and/or data storage infrastructures 20,22 sufficient to support pathways for accomplishing the transaction processing and/or data storage processes for such financial transactions.

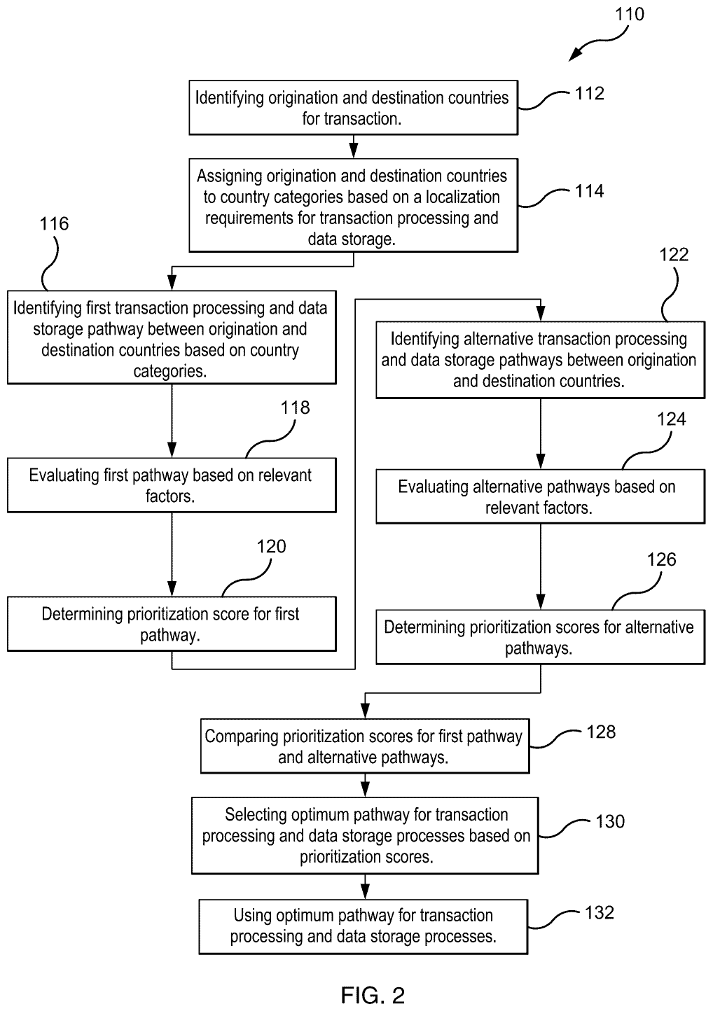

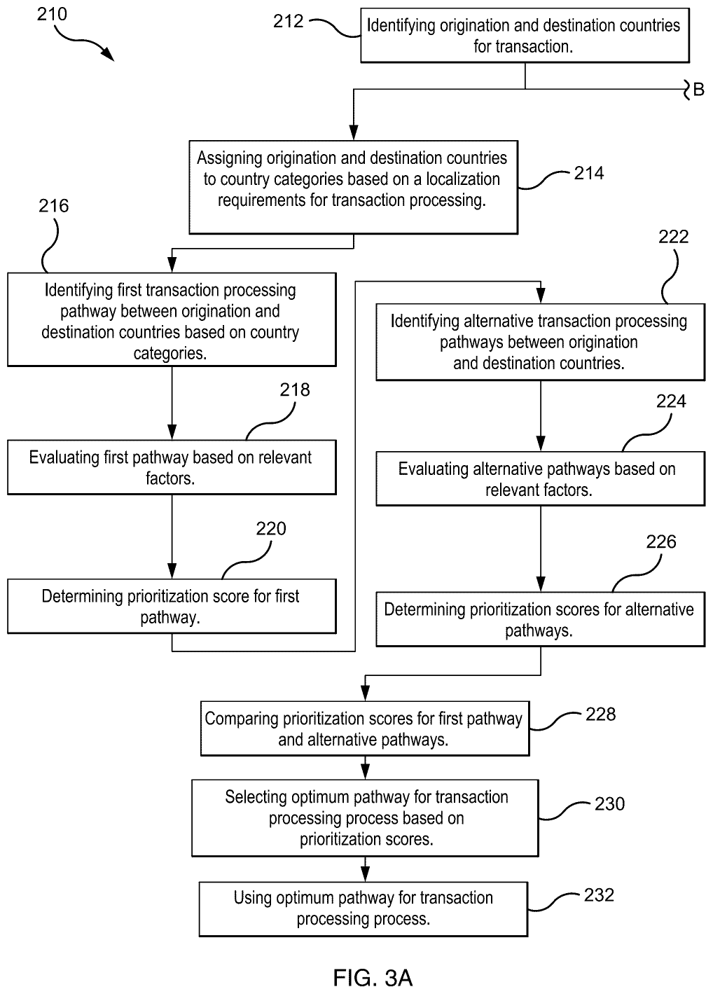

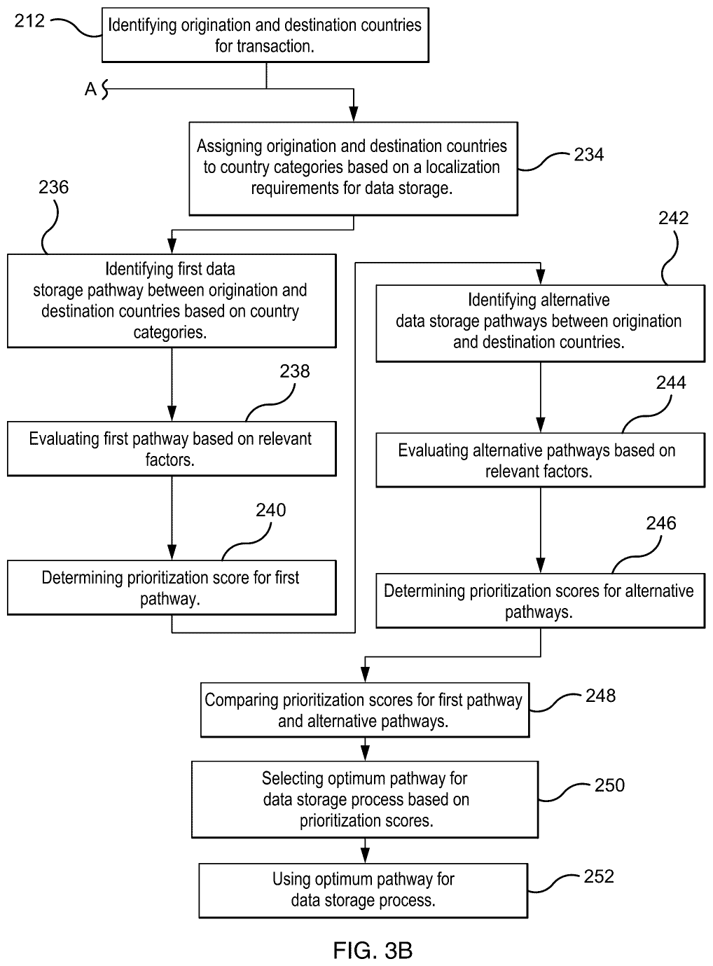

The optimum pathway identification module 26 may be substantially any computing device configured to function as follows. The function of the pathway module 26 may be similar or identical to the steps of the methods 120,220 discussed below and shown in FIGS. 2 and 3. For the purpose of description, reference is made to the steps of the first method 120 and FIG. 2. The transaction origination country 14 and destination country 18 for the international financial transaction may be identified, as shown in 112 of FIG. 2. The origination country 14 may be assigned to a first country category based on a first set of localization requirements for the transaction processing and data storage processes, and the destination country 18 may be assigned to a second country category based on a second set of localization requirements for the same processes, as shown in 114.

An example categorization scheme may include five (5) categories: global, light, medium_1, medium_2, and strict. A “global” (G) country may allow for global transaction processing and global data storage. A “light” (L) country may allow for cross border data transaction processing and cross border data storage with a local copy. A “medium_1” (M1) country may allow for only local data transaction processing and cross border data storage with a local copy. A “medium_2” (M2) country may allow for cross border data transaction processing and only local data storage. A “strict” (S) country may allow for only local transaction processing and only local data processing. Thus, using this example scheme, the relevant countries may be categorized as G, L, M1, M2, or S. Generally, each country's limits on transaction processing and data storage apply to transactions originating in that country and not to transactions originating elsewhere and passing through that country. Having said that, implementations of the present invention can accommodate situations in which a country's limits on transaction processing and data storage also apply to transactions originating elsewhere and passing through that country.

A first transaction processing and data storage pathway (Pathway_1) between the origination country 14 and the destination country 18 may be identified based on the first country category and the second country category, as shown in 116. The first transaction processing and data storage pathway may route through an intermediate country. The first transaction processing and data storage pathway may be evaluated based on one or more relevant factors, as shown in 118, and a prioritization score may be determined for the first transaction processing and data storage pathway, as shown in 120. In one implementation, the relevant factors may include the availability of relevant infrastructure (e.g., a cloud service provider); the financial cost of using the available infrastructure; and the latency, or performance cost (e.g., time), of using the available infrastructure. In one implementation, the prioritization score may be determined using the following equation:

$$S = \frac{{P}_{n}^{C} \times {P}_{n}^{L}}{\sum ( {P}_{i}^{C} \times {P}_{i}^{L} )} + \frac{{D}_{n}^{C} \times {D}_{n}^{L}}{\sum ( {D}_{i}^{C} \times {D}_{i}^{L} )}$$

where,

$${P}_{i}^{C}$$

is the transaction processing score's cost component for the i^{th} path;

$${P}_{i}^{L}$$

is the transaction processing score's latency component for the i^{th} path;

$${D}_{i}^{C}$$

is the data storage score's cost component for the i^{th} path; and

$${D}_{i}^{L}$$

is the data storage score's latency component for the i^{th} path.

One or more alternative transaction processing and data storage pathways (Pathway_2 through Pathway_N) between the origination country 14 and the destination country 16 using the transaction processing infrastructures 20 and data storage infrastructures 22 located in intermediate countries 24 may be identified, as shown in 122. The one or more alternative transaction processing and data storage pathways may be evaluated based on the one or more relevant factors, as shown in 124, and a prioritization score may be determined for each of the one or more alternative transaction processing and data storage pathways, as shown in 126. The evaluations of and assignations of prioritization scores to the alternative pathways may proceed substantially similar or identical to that of the first pathway (e.g., using the equation shown above or a version thereof). The prioritization scores for the first transaction processing and data storage pathway and the one or more alternative transaction processing and data storage pathways may be compared, as shown in 128. An optimum pathway for the transaction processing and data storage processes may be selected based on this comparison of the prioritization scores, as shown in 130, and the optimum pathway may be used for the transaction processing and data storage processes, as shown in 132. It will be appreciated that even if all of the relevant countries are in the “global” category, the present invention still provides a benefit by identifying the optimum path with regard to the relevant evaluation factors.

Referring to FIG. 2, a first embodiment of a method 110 is shown for facilitating an international financial transaction by evaluating, based on, e.g., cost and latency factors, multiple international pathways for transaction processing and data storage and identifying and using an optimum pathway for these process between the transaction origination and destination countries. In this implementation, the transaction processing and data storage processes may use the same optimum pathway. Some or all of the steps of the method 110 may be implemented using components of the system 10 described above or a similar system.

The transaction origination country 14 and destination country 18 for the international financial transaction may be identified, as shown in 112. The origination country 14 may be assigned to a first country category based on a first set of localization requirements for the transaction processing and data storage processes, and the destination country 18 may be assigned to a second country category based on a second set of localization requirements for the same processes, as shown in 114.

An example categorization scheme may include five (5) categories: global, light, medium_1, medium_2, and strict. A “global” (G) country may allow for global transaction processing and global data storage. A “light” (L) country may allow for cross border data transaction processing and cross border data storage with a local copy. A “medium_1” (M1) country may allow for only local data transaction processing and cross border data storage with a local copy. A “medium_2” (M2) country may allow for cross border data transaction processing and only local data storage. A “strict” (S) country may allow for only local transaction processing and only local data processing. Thus, using this example scheme, the relevant countries may be categorized as G, L, M1, M2, or S. Generally, each country's limits on transaction processing and data storage apply to transactions originating in that country and not to transactions originating elsewhere and passing through that country. Having said that, implementations of the present invention can accommodate situations in which a country's limits on transaction processing and data storage also apply to transactions originating elsewhere and passing through that country.

A first transaction processing and data storage pathway (Pathway_1) between the origination country 14 and the destination country 18 may be identified based on the first country category and the second country category, as shown in 116. The first transaction processing and data storage pathway may route through an intermediate country. The first transaction processing and data storage pathway may be evaluated based on one or more relevant factors, as shown in 118, and a prioritization score may be determined for the first transaction processing and data storage pathway, as shown in 120. In one implementation, the relevant factors may include the availability of relevant infrastructure (e.g., a cloud service provider); the financial cost of using the available infrastructure; and the latency, or performance cost (e.g., time), of using the available infrastructure. In one implementation, the prioritization score may be determined using the following equation:

$$S = \frac{{P}_{n}^{C} \times {P}_{n}^{L}}{\sum ( {P}_{i}^{C} \times {P}_{i}^{L} )} + \frac{{D}_{n}^{C} \times {D}_{n}^{L}}{\sum ( {D}_{i}^{C} \times {D}_{i}^{L} )}$$

where,

$${P}_{i}^{C}$$

is the transaction processing score's cost component for the i^{th} path;

$${P}_{i}^{L}$$

is the transaction processing score's latency component for the i^{th} path;

$${D}_{i}^{C}$$

is the data storage score's cost component for the i^{th} path; and

$${D}_{i}^{L}$$

is the data storage score's latency component for the i^{th} path.

One or more alternative transaction processing and data storage pathways (Pathway_2 through Pathway_N) between the origination country 14 and the destination country 16 using the transaction processing infrastructures 20 and data storage infrastructures 22 located in intermediate countries 24 may be identified, as shown in 122. The one or more alternative transaction processing and data storage pathways may be evaluated based on the one or more relevant factors, as shown in 124, and a prioritization score may be determined for each of the one or more alternative transaction processing and data storage pathways, as shown in 126. The evaluations of and assignations of prioritization scores to the alternative pathways may proceed substantially similar or identical to the first pathway. The prioritization scores for the first transaction processing and data storage pathway and the one or more alternative transaction processing and data storage pathways may be compared, as shown in 128. An optimum pathway for the transaction processing and data storage processes may be selected based on this comparison of the prioritization scores, as shown in 130, and the optimum pathway may be used for the transaction processing and data storage processes, as shown in 132. It will be appreciated that even if all of the relevant countries are in the “global” category, the present invention still provides a benefit by identifying the optimum path with regard to the relevant evaluation factors.

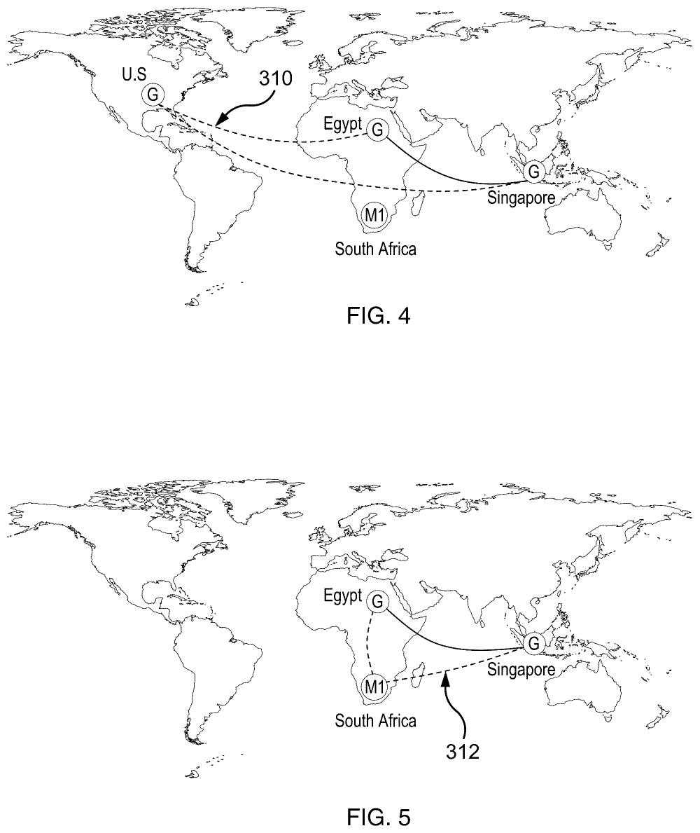

Referring also to FIG. 4, a depiction is shown of an example default, non-optimal transaction processing and data storage pathway 310 for an example first international financial transaction. The example default pathway is superimposed over a map of the world showing Egypt (a “G” category country) as the transaction origination country, Singapore (a “G” category country) as the transaction destination country, and the U.S. (a “G” category country) as the intermediate country. FIG. 5 shows a depiction of an example optimum transaction processing and data storage pathway 312 for the same financial transaction as FIG. 4 with South Africa (an “M1” category country) as the intermediate country as identified and used by an embodiment of the present invention.

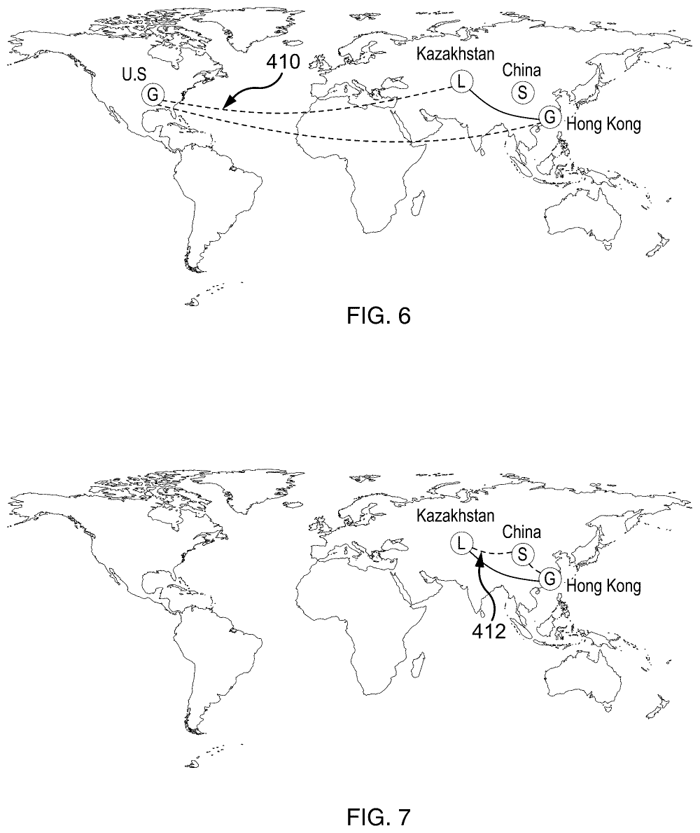

Similarly, referring also to FIG. 6, a depiction is shown of an example default, non-optimal transaction processing and data storage pathway 410 for an example first international financial transaction. The example default pathway is superimposed over a map of the world showing Kazakhstan (an “L” category country) as the transaction origination country, Hong Kong (a “G” category country) as the transaction destination country, and the U.S. (a “G” category country) as the intermediate country. FIG. 7 shows a depiction of an example optimum transaction processing and data storage pathway 312 for the same financial transaction as FIG. 5 with China (an “S” category country) as the intermediate country as identified and used by an embodiment of the present invention.

Referring to FIGS. 3A and 3B, a second embodiment of a method 210 is shown for facilitating an international financial transaction by evaluating, based on, e.g., cost and latency factors, multiple international paths for transaction processing and data storage and identifying and using an optimum pathway for these processes between the transaction origination and destination countries. In this implementation, the transaction processing process may use an optimum transaction processing pathway and the data storage process may use an optimum data storage pathway, and the two pathways may or may not be different depending on the separate evaluations and scoring. Some or all of the steps of the method 210 may be implemented using components of the system 10 described above or a similar system.

The transaction origination country 14 and destination country 18 for the international financial transaction may be identified, as shown in 212. It will be appreciated that the subsequent steps 214 through 232 for determining the optimum transaction processing pathway may occur independently of and/or simultaneously with the steps 234 through 252 for determining the optimum data storage pathway. The origination country 14 may be assigned to a first country transaction processing (TP) category based on a first set of localization requirements for the transaction processing process, and the destination country may be assigned to a second country TP category based on a second set of localization requirements for the same process, as shown in 212 (see the example categorization scheme described above).

A first TP pathway between the origination country 14 and the destination country 18 may be identified based on the first country TP category and the second country TP category, as shown in 216. The first TP pathway may route through an intermediate country. The first TP pathway may be evaluated based on one or more relevant TP factors, as shown in 218, and a TP prioritization score may be determined for the first TP pathway, as shown in 220. In one implementation, relevant transaction processing factors may include the availability of relevant infrastructure (e.g., a cloud service provider); the financial cost of using the available infrastructure; and the latency, or performance cost (e.g., time), of using the available infrastructure. In one implementation, relevant factors for cost and latency scores for transaction processing may include processing region location; type of infrastructure (local or cloud); transaction volume processing requirement; and software licensing cost for the region. Ways to reduce cost and latency scores for transaction processing include distributed processing; content delivery networks (CDNs); automated infrastructure management; containerization and serverless architecture implementations; deployment in low-cost regions; and hybrid cloud implementation (local and cloud). In one implementation, the TP prioritization score may be determined using the following equation:

$${S}_{T P} = \frac{{P}_{n}^{C} \times {P}_{n}^{L}}{\sum ( {P}_{i}^{C} \times {P}_{i}^{L} )}$$

where,

$${P}_{i}^{C}$$

is the transaction processing score's cost component for the i^{th} path;

$${P}_{i}^{L}$$

is the transaction processing score's latency component for the i^{th} path; and

One or more alternative TP pathways between the origination country 14 and the destination country 18 using the transaction processing infrastructures 20 located in intermediate countries 24 may be identified, as shown in 222. The one or more alternative TP pathways may be evaluated based on the one or more relevant TP factors, as shown in 224, and a TP prioritization score may be determined for each of the one or more alternative transaction processing pathways, as shown in 226. The evaluations of and assignations of prioritization scores to the alternative TP pathways may proceed substantially similar or identical to the first TP pathway. The TP prioritization scores for the first TP pathway and the one or more alternative TP pathways may be compared, as shown in 228. An optimum TP pathway for the transaction processing process may be selected based on the comparison of the TP prioritization scores, as shown in 230, and the optimum TP pathway may be used for the transaction processing process, as shown in 232.

The origination country 14 may be assigned to a first country data storage (DS) category based on a first set of localization requirements for the data storage process, and the destination country 18 may be assigned to a second country DS category based on a second set of localization requirements for the same process, as shown in 234 (see the example categorization scheme described above).

A first DS pathway between the origination country 14 and the destination country 18 may be identified based on the first country DS category and the second country DS category, as shown in 234. The first DS pathway may route through an intermediate country. The first DS pathway may be evaluated based on one or more relevant factors, as shown in 244, and a DS prioritization score may be determined for the first DS pathway, as shown in 246. In one implementation, relevant DS factors may include the availability of relevant infrastructure (e.g., a cloud service provider); the financial cost of using the available infrastructure; and the latency, or performance cost (e.g., time), of using the available infrastructure. In one implementation, relevant factors for cost and latency scores for data storage may include data security compliance and regulatory requirements; storage requirements (solid state drives (SSDs)/hard disk drives (HDDs)); geographic distribution; and vendor and service provider pricing. Ways to reduce cost and latency scores for data storage include use of cloud data storage; intelligent storage tiering; data caching and CDN usage; evaluate storage pricing models as provided by vendors; data archiving and purging; and data compression and de-duplication. In one implementation, the DS prioritization score may be determined using the following equation:

$${S}_{D S} = \frac{{D}_{n}^{C} \times {D}_{n}^{L}}{\sum ( {D}_{i}^{C} \times {D}_{i}^{L} )}$$

where

$${D}_{i}^{C}$$

is the data storage score's cost component for the i^{th} path; and

$${D}_{i}^{L}$$

is the data storage score's latency component for the i^{th} path.

One or more alternative DS pathways between the origination country 14 and the destination country 18 using the data storage infrastructures 22 located in intermediate countries 24 may be identified, as shown in 242. The one or more alternative DS pathways may be evaluated based on the one or more relevant factors, as shown in 244, and a DS prioritization score may be determined (using, e.g., the equation set forth above) for each of the one or more alternative DS pathways, as shown in 246. The evaluations of and assignations of prioritization scores to the alternative pathways may proceed substantially similar or identical to the first pathway. The DS prioritization scores for the first DS pathway and the one or more alternative DS pathways may be compared, as shown in 248. An optimum DS pathway for the data storage process may be selected based on this comparison of DS prioritization scores, as shown in 250, and the optimum DS pathway may be used for the data storage processes, as shown in 252. It will be appreciated that even if all of the relevant countries are in the “global” category, the present invention still provides a benefit by identifying the optimum path with regard to the relevant evaluation factors.

The prioritization scores for the pathways will not necessarily remain static over time. Strategizing data center growth and improving cloud storage can increase optimization values for different paths. For example, by optimizing cloud storage and data center growth, businesses can reduce their infrastructure costs. They can scale up or down their storage needs as required, avoiding the need to purchase and maintain expensive hardware that may become obsolete quickly. Additionally, with cloud storage, businesses can quickly scale up their storage capacity to meet their changing needs. This allows them to respond to changes in demand and to easily accommodate growth. Additionally, by optimizing cloud storage and data center growth, businesses can enhance their data security. Cloud providers often have robust security measures in place, including encryption and access controls, to protect data from cyber threats. Additionally, modern data centers are designed to be highly secure, with multiple layers of physical and digital security measures. By leveraging cloud storage and optimizing data center growth, businesses can increase their agility. They can quickly deploy new applications and services, enabling them to respond to market changes and customer needs more effectively. Additionally, cloud storage and modern data centers offer robust disaster recovery capabilities, such as automatic backups and redundant systems. This can help businesses recover from outages or disasters quickly, minimizing downtime and data loss. Additionally, by optimizing cloud storage and data center growth, businesses can improve their overall performance. Modern data centers are designed to provide high-speed connectivity and low latency, enabling businesses to process large volumes of data quickly.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for facilitating an international financial transaction involving a payment card, the system comprising:
a merchant located in a transaction origination country associated with a first set of localization requirements for a transaction processing process and a data storage process;
an issuer of the payment card located in a transaction destination country associated with a second set of localization requirements for the transaction processing process and the data storage process;
one or more transaction processing infrastructures and one or more data storage infrastructures located in one or more intermediate countries; and
an optimum pathway identification module configured to:
identify the transaction origination country and the transaction destination country for the international financial transaction involving the payment card,
assign the transaction origination country to a first country category based on the first set of localization requirements for the transaction processing process and the data storage process,
assign the transaction destination country to a second country category based on the second set of localization requirements for the transaction processing process and the data storage process,
identify a first transaction processing and data storage pathway between the transaction origination country and the transaction destination country based on the first country category and the second country category,
evaluate the first transaction processing and data storage pathway based on one or more relevant factors,
determine a first prioritization score based on the one or more relevant factors for the first transaction processing and data storage pathway;
identify one or more alternative transaction processing and data storage pathways between the transaction origination country and the transaction destination country through the one or more intermediate countries,
evaluate the one or more alternative transaction processing and data storage pathways based on the one or more relevant factors,
determine an alternative prioritization score based on the one or more relevant factors for each of the one or more alternative transaction processing and data storage pathways,
compare the first prioritization score for the first transaction processing and data storage pathway and the alternative prioritization score for each of the one or more alternative transaction processing and data storage pathways,
select an optimum pathway for the transaction processing process and the data storage process based on comparing the prioritization scores, and
use the optimum pathway for the transaction processing process and the data storage process to facilitate the international financial transaction involving the payment card.

2. (canceled)

3. The system of claim 1, wherein the first transaction processing and data storage pathway includes an intermediate country.

4. The system of claim 1, wherein there is a single optimum pathway for both the transaction processing process and the data storage process.

5. The system of claim 1, wherein the one or more relevant factors include—
an available infrastructure;
a financial cost of using the available infrastructure; and
a performance cost, including a time cost, of using the available infrastructure.

6. The system of claim 1, wherein the one or more relevant factors for the transaction processing process include—
a region;
a type of transaction processing infrastructure;
a transaction volume processing requirement; and
a licensing cost for a transaction processing software.

7. The system of claim 1, wherein the one or more relevant factors for the data storage process include—
a data security compliance and regulatory requirements;
a storage requirement;
a geographic distribution; and
a pricing for relevant vendors and service providers.

8. A method for facilitating an international financial transaction involving a payment card, the method comprising:
identifying an origination country and a destination country for the international financial transaction involving the payment card;
assigning the origination country to a first country category based on a first set of localization requirements for a transaction processing process and a data storage process;
assigning the destination country to a second country category based on a second set of localization requirements for the transaction processing process and the data storage process;
identifying a first transaction processing and data storage pathway between the origination country and the destination country based on the first country category and the second country category;
evaluating the first transaction processing and data storage pathway based on one or more relevant factors;
determining a first prioritization score based on the one or more relevant factors for the first transaction processing and data storage pathway;
identifying one or more alternative transaction processing and data storage pathways between the origination country and the destination country through one or more intermediate countries;
evaluating the one or more alternative transaction processing and data storage pathways based on the one or more relevant factors;
determining an alternative prioritization score based on the one or more relevant factors for each of the one or more alternative transaction processing and data storage pathways;
comparing the first prioritization score for the first transaction processing and data storage pathway and the alternative prioritization score for each of the one or more alternative transaction processing and data storage pathways;
selecting an optimum pathway for the transaction processing process and the data storage process based on comparing the first prioritization score and the alternative prioritization score; and
using the optimum pathway for the transaction processing process and the data storage process to facilitate the international financial transaction involving the payment card.

9. (canceled)

10. The method of claim 8, wherein the first transaction processing and data storage pathway includes an intermediate country.

11. The method of claim 8, wherein there is a single optimum pathway for both the transaction processing process and the data storage process.

12. The method of claim 8, wherein the one or more relevant factors include—
an available infrastructure;
a financial cost of using the available infrastructure; and
a performance cost, including a time cost, of using the available infrastructure.

13. The method of claim 8, wherein the one or more relevant factors for the transaction processing process include—
a region;
a type of transaction processing infrastructure;
a transaction volume processing requirement; and
a licensing cost for a transaction processing software.

14. The method of claim 8, wherein the one or more relevant factors for the data storage process include—
a data security compliance and regulatory requirements;
a storage requirement;
a geographic distribution; and
a pricing for relevant vendors and service providers.

15. A method for facilitating an international financial transaction involving a payment card, the method comprising:
identifying an origination country and a destination country for the international financial transaction involving the payment card;
assigning the origination country to a first transaction processing country category based on a first set of transaction processing localization requirements for a transaction processing process;
assigning the destination country to a second transaction processing country category based on a second set of transaction processing localization requirements for the transaction processing process;
identifying a first transaction processing pathway between the origination country and the destination country based on the first transaction processing country category and the second transaction processing country category;
evaluating the first transaction processing pathway based on one or more relevant factors;
determining a first transaction processing prioritization score based on the one or more relevant factors for the first transaction processing pathway;
identifying one or more alternative transaction processing pathways between the origination country and the destination country through one or more intermediate countries;
evaluating the one or more alternative transaction processing pathways based on the one or more relevant factors;
determining an alternative transaction processing prioritization score based on the one or more relevant factors for each of the one or more alternative transaction processing pathways;
comparing the first transaction processing prioritization score for the first transaction processing pathway and the alternative transaction processing prioritization score for each of the one or more alternative transaction processing pathways;
selecting an optimum transaction processing pathway for the transaction processing process based on comparing the first transaction processing prioritization score and the alternative transaction processing prioritization score for each of the one or more alternative transaction processing pathways; and
using the optimum transaction processing pathway for the transaction processing process;
assigning the origination country to a first data storage country category based on a first set of data storage localization requirements for a data storage process;
assigning the destination country to a second data storage country category based on a second set of data storage localization requirements for the data storage process;
identifying a first data storage pathway between the origination country and the destination country based on the first data storage country category and the second data storage country category;
evaluating the first data storage pathway based on one or more relevant factors;
determining a first data storage prioritization score based on the one or more relevant factors for the first data storage pathway;
identifying one or more alternative data storage pathways between the origination country and the destination country through one or more intermediate countries;
evaluating the one or more alternative data storage pathways based on the one or more relevant factors;
determining an alternative data storage prioritization score based on the one or more relevant factors for each of the one or more alternative data storage pathways;
comparing the first data storage prioritization score for the first data storage pathway and the alternative prioritization score for each of the one or more alternative data storage pathways;
selecting an optimum data storage pathway for the data storage process based on the comparison of the first data storage prioritization score and the alternative data storage prioritization score for each of the one or more alternative data storage pathways; and
using the optimum data storage pathway for the data storage process to facilitate the international financial transaction involving the payment card.

16. (canceled)

17. The method of claim 15, wherein at least one of the first transaction processing pathway and the first data storage pathway includes an intermediate country.

18. The method of claim 15, wherein the one or more relevant factors include—
an available infrastructure;
a financial cost of using the available infrastructure; and
a performance cost, including a time cost, of using the available infrastructure.

19. The method of claim 15, wherein the one or more relevant factors for the transaction processing process include—
a region;
a type of transaction processing infrastructure;
a transaction volume processing requirement; and
a licensing cost for a transaction processing software.

20. The method of claim 15, wherein the one or more relevant factors for the data storage process include—
a data security compliance and regulatory requirements;
a storage requirement;
a geographic distribution; and
a pricing for relevant vendors and service providers.
